(19) United States
(12) Patent Application Publication
(10) Pub. No.: US 2007/0125986 A1
(43) Pub. Date: Jun. 7, 2007

(54) COMPOSITION FOR DISSOLVING TITANIUM OXIDE AND DISSOLUTION METHOD USING IT

(75) Inventors: Yasushi HARA, Yamaguchi-ken (JP); Masahiro Aoki, Yamaguchi-ken (JP); Hiroaki Hayashi, Yamaguchi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOSOH CORPORATION

(21) Appl. No.: 11/673,961

(22) Filed: Feb. 12, 2007

Related U.S. Application Data
(62) Division of application No. 10/914,197, filed on Aug. 10, 2004.

(51) Int. Cl. B01F 1/00

(52) U.S. Cl. 252/364

(57) ABSTRACT

A composition for dissolving a titanium oxide, which comprises carbonic acid and/or a carbonate, hydrogen peroxide and water.

### BACKGROUND OF THE INVENTION

1. Field of the Invention

The present invention relates to a composition for dissolving a titanium oxide and a dissolution method using it.

2. Discussion of Background

A titanium oxide, particularly titanium dioxide is a compound hardly soluble in water. A titanium oxide covers a titanium metal surface as a film. Further, it is produced as an impurity in a step for producing semiconductors or in a step for producing LCD modules, or contained in a metal oxide such as silica, alumina or ceria as an impurity. At the time of a surface treatment of the titanium metal, the removal of the impurity in the step for producing semiconductors or in the step for producing LCD modules, or the removal of the impurity in the metal oxide such as silica, alumina or ceria, it is necessary to carry out special method to remove the titanium oxide which is hardly soluble in water.

The most common method is a method using hydrogen peroxide under acidic conditions. A titanium oxide is solubilized in water by hydrogen peroxide. However, in such a method, the solubility of the titanium oxide is low, whereby heating is required. It involves a risk to heat decomposable one such as hydrogen peroxide, whereby it is difficult to say that the method is industrially effective.

Further, it is common to use hydroxylamine under basic conditions in the step for producing semiconductors or in the step for producing LCD modules. Also in a case where hydroxylamine is used, the titanium oxide is solubilized in water. However, hydroxylamine is a very unstable compound, and there is a risk of explosion, whereby there is a problem to dissolve a titanium oxide industrially.

Therefore, it has been desired to develop a composition which dissolves a titanium oxide under safe conditions without using a dangerous material such as hydroxylamine.

As mentioned above, it has been desired to develop a composition which dissolves a titanium oxide under safe conditions without using a dangerous material such as hydroxylamine. Therefore, it is an object of the present invention to provide a composition for dissolving a titanium oxide safely and a dissolution method using it.

### SUMMARY OF THE INVENTION

The present inventors have conducted extensive studies on a composition for dissolving a titanium oxide, and a as a result, have found that a titanium oxide is readily dissolved even at room temperature by using a composition which comprises carbonic acid and/or a carbonate, hydrogen peroxide and water, or carbonic acid and/or a carbonate, ozone and water. The present invention has been accomplished on the basis of this discovery.

Namely, the present invention provides a composition for dissolving a titanium oxide, which comprises carbonic acid and/or a carbonate, hydrogen peroxide and water, or carbonic acid and/or a carbonate, ozone and water, and a dissolution method using them.

### DETAILED DESCRIPTION OF THE PREFERRED EMBODIMENTS

Now, the present invention will be described in further detail.

One of the compositions for dissolving a titanium oxide of the present invention comprises carbonic acid and/or a carbonate, hydrogen peroxide and water.

In the composition of the present invention, the carbonic acid represents an aqueous carbon dioxide solution. The carbonate represents a salt of H₂CO₃, and it is classified into a normal salt, an acid salt (hydrogencarbonate) and a basic salt. In general, it is prepared by reacting a metal oxide or hydroxide with carbon dioxide in the presence of water. The carbonate to be used in the composition of the present invention is preferably one which is soluble in water.

As the carbonate which is soluble in water, an ammonium salt, an alkali metal carbonate or tellurium carbonate may, for example, be mentioned. However, in a use in which the presence of metal ions is undesirable (for example, semiconductor production), an ammonium salt is particularly preferred. In the method of the present invention, the ammonium salt represents a salt of ammonia or a carbonate of tertiary ammonium. Ammonium carbonate is usually distributed as a mixture of ammonium carbonate, ammonium hydrogencarbonate and ammonium to carbamate, and such a mixture can also be used. Further, it is known that an aqueous ammonium carbonate solution is decomposed into carbonic acid and ammonia at 70° C., and it can also be used in a state where it is decomposed into carbonic acid and ammonia.

In the composition of the present invention, the form of the hydrogen peroxide to be used is not restricted. Hydrogen peroxide may be used alone, or e.g. a solution such as a hydrogen peroxide solution may also be used.

In the composition of the present invention, the form of the water to be used is also not restricted. Water may be used alone, or a mixed solution with e.g. another organic solvent or an aqueous solution having a salt, an acid, a base or the like added may be also used.

In the composition of the present invention, the ratio of the carbonic acid and/or the carbonate, the hydrogen peroxide and the water is not limited since it greatly changes depending upon the use, the use condition and the type of the carbonate. However, it is usually preferred that the content of the carbonic acid or the carbonate (the total amount in a case of combination use) is from 0.01 to 40 wt %, the content of the hydrogen peroxide is from 10 ppm to 35 wt %, and the content of the water is from 25 to 99.9 wt %, on the basis of the total weight of the composition for dissolving a titanium oxide. It is more preferred that the content of the carbonic acid (carbonate) is from 0.1 to 30 wt %, the content of the hydrogen peroxide is from 100 ppm to 31 wt %, and the content of the water is from 39 to 99.9 wt %

If the carbonic acid (carbonate) is less than 0.01 wt %, dissolution of a titanium oxide is too slow for practical use. If it exceeds 40 wt %, the carbonic acid (carbonate) is hardly dissolved in an aqueous solution, such being impractical.

With respect to the hydrogen peroxide, if it is less than 10 ppm, dissolution of a titanium oxide is too slow for practical use, and hydrogen peroxide exceeding 35 wt % is dangerous and is not usually distributed on the market, whereby it can not be used industrially.

Further, with respect to the water, if it is less than 25 wt %, the carbonic acid is hardly dissolved in an aqueous solution, and if it exceeds 99.9 wt %, dissolution of a titanium oxide is too slow for practical use.

To the above composition of the present invention, a water soluble organic solvent may further be added. The water soluble organic solvent which can be added to the composition of the present invention is not particularly limited, but an alcohol such as methanol, ethanol, propanol or butanol; an ether such as tetrahydrofuran; an ether alcohol; an ester such as a carbonate, methyl acetate or ethyl acetate; an amide such as dimethylformamide, dimethylacetamide, methylpyrrolidone or dimethyl imidazolidinone; a sulfoxide such as dimethylsulfoxide; or an amine oxide such as dimethyldodecylamine oxide or methylmorpholine oxide may, for example, be mentioned. Such water soluble organic solvents may be used alone, or at least two members may be used as mixed. Among these water soluble organic solvents, an ether alcohol and a carbonate are particularly preferred since the decomposition of hydrogen peroxide is little.

As the ether alcohol which can be added to the composition of the present invention, various ones may be used. For example, an ether alcohol having the following formula (1) or (2) may be used.
R₁OR₂OH (1)
R₁OR₂OR₃OH (2)
wherein R₁ represents a C₁₋₅ alkyl group, and each of R₂ and R₂ represents a C₁₋₅ linear or branched alkylene group.

As the ether alcohol corresponding to the formula (1), butoxypropanol, butoxyethanol, propoxypropanol, propoxyethanol, ethoxypropanol, ethoxyethanol, methoxypropanol or methoxyethanol may, for example, be mentioned. As the ether alcohol corresponding to the formula (2), dipropylene glycol monobutyl ether, dipropylene glycol monopropyl ether, dipropylene glycol monoethyl ether, dipropylene glycol monomethyl ether, diethylene glycol monobutyl ether, diethylene glycol monopropyl ether, diethylene glycol monoethyl ether or diethylene glycol monomethyl ether may, for example, be mentioned. They may be used alone, or at least two members may be used as mixed.

As the carbonate which can he added to the composition of the present invention, a compound of the following formula may, for example, be mentioned.
R₁O—CO—OR₂
wherein each of R₁ and R₂ represents a C₁₋₅ alkyl group, or R₁ and R₂ together may form a ring having a carbon number of from 1 to 5.

As a specific compound of the above formula, diethyl carbonate, dimethyl carbonate, ethylene carbonate or propylene carbonate may, for example, be mentioned. They may be used alone, or at least two members may be used as mixed.

The content of the water soluble organic solvent which can be added to the composition of the present invention is preferably from 0.1 to 70 wt %, more preferably from 1 to 50 wt % on the basis of the total weight of the composition for dissolving a titanium oxide. When the water soluble organic solvent is added, the stability of the hydrogen peroxide tends to increase, and further, the damage to the material other than the titanium oxide tends to decrease. If the content of the water soluble organic solvent is less than 1 wt %, the effect by adding the water soluble organic solvent tends to be small, and if it exceeds 70 wt %, the dissolution rate of the titanium oxide tends to be too low for industrial use.

The other composition for dissolving a titanium oxide of the present invention is one comprising carbonic acid and/or a carbonate, ozone and water.

Here, the carbonic acid represents an aqueous carbon dioxide solution. The carbonate represents a salt of H₂CO₃, and it is classified into a normal salt, an acid salt (hydrogencarbonate) and a basic salt. In general, it is prepared by reacting a metal oxide or hydroxide with carbon dioxide in the presence of water. The carbonate to be used in the method of the present invention is preferably one which is soluble in water.

As the carbonate which is soluble in water, an ammonium salt, an alkali metal salt or a tellurium salt may, for example, be mentioned. In a use in which the presence of metal ions is undesirable (for example semiconductor production), an ammonium salt is particularly preferred. In the method of the present invention, the ammonium salt represents a salt of ammonia and carbonic acid, a salt of an amine and carbonic acid or a carbonate of tertiary ammonium. Ammonium carbonate is usually distributed on the market as a mixture of ammonium carbonate, ammonium hydrogencarbonate and ammonium carbamate, and such a mixture can also be used. Further, it is known that an aqueous ammonium carbonate solution is decomposed into carbonic acid and ammonia at 70° C., and it can also be used in a state where it is decomposed into carbonic acid and ammonia.

In the present invention, the form of the ozone to be used is not restricted. Ozone may be used alone, or a mixture with another gas, a solution such as ozone water or the like may be used

In the present invention, the form of the water to be used is not restricted also. Water may be used alone, or a mixed solution with e.g. another organic solvent or an aqueous solution having a salt, an acid, a base or the like added may be also used. As the water to be used in the present invention, deionized water is preferred so as not to pollute the material to be dissolved when the titanium oxide is dissolved.

In the present invention, the ratio of the carbonic acid and/or the carbonate, the ozone and the water greatly changes depending upon the use, the use condition or the type of the carbonate, whereby it is difficult to limit it. However, if it is exemplified, as for the carbonic acid, it is preferably from 0.01 to 40 wt %, more preferably from 0.1 to 30 wt %. If it is less than 0.01 wt %, peeling of the titanium oxide is too slow for practical use, and if it exceeds 40 wt %, the carbonic acid is hardly dissolved in an aqueous solution, such being impractical. As for the ozone, the change is remarkable depending upon the pressure, the amount of the carbonic acid, the temperature or the like, whereby it is difficult to limit it. However, it is preferably from 10 ppm to 5 wt %, more preferably from 100 ppm to 1 wt %. If it is less than 10 ppm, peeling of the titanium oxide is too slow for practical use, and it is difficult to dissolve ozone in an amount exceeding 5 wt % under usual use condition, such being impractical.

Then, in the method for dissolving a titanium oxide by using the composition for dissolving a titanium oxide of the present invention, the temperature for dissolving the titanium oxide is from 20 to 100° C., preferably from 30 to 90° C. if it is less than 20° C., the dissolution rate of the titanium oxide tends to be unrealistically slow. If the temperature exceeds 100° C., the carbonic acid or the ozone is not dissolved in water, whereby solubility decrease in some cases.

The method of the present invention can be applied to various fields in which a titanium oxide is subjected to a dissolution treatment. For example, a surface treatment of titanium metal, removal of impurities in a step for producing semiconductors or in a step for producing LCD modules, and removal of impurities in a metal oxide such as silica, alumina or ceria may be mentioned.

The surface of titanium metal is covered thinly with a titanium oxide as a film, whereby it is stabilized. Therefore, it is necessary to dissolve the film of the titanium oxide for treating the metal surface, and the composition of the present invention can be suitably applied in this case.

Further, in the step for producing semiconductors or in the step for producing LCD modules, titanium is an important element, but a titanium oxide is deposited on a semiconductor wafer or a LCD module as a by-product, which causes a decrease in the yield of the semiconductor or the LCD. Heretofore, hydroxylamine has been used to remove the titanium oxide. However, as an alternative to the method by hydroxylamine, the method of the present invention can be suitably applied.

Further, the metal oxide such as silica, alumina or ceria is largely used as a semiconductor material, whereby it is required to have a high purity. The method using the composition of the present invention is also effective for the removal of the titanium oxide which is present as an impurity in such metal oxide.

Now, the present invention will be described in further detail with reference to Examples. However, it should be understood that the present invention is by no means restricted thereto.

### EXAMPLE 1

In 10 g of a 35% hydrogen peroxide solution, 1 g of ammonium carbonate (including ammonium hydrogencarbonate and ammoniumn carbonate) was dissolved.

In the mixed liquid, a titanium metal foil was immersed for 10 minutes at room temperature. The surface of the titanium metal foil is covered with a titanium oxide, and when the titanium oxide is dissolved and removed, the titanium metal foil will be discolored. The dissolution of the titanium oxide can be readily tested by this method. The titanium metal foil was immersed in the above mixed liquid and as a result, the titanium metal foil was discolored, and it was found that the surface titanium oxide was dissolved.

### EXAMPLES 2 TO 8, COMPARATIVE EXAMPLES 1 AND 2

In the aqueous solution of the composition with the concentration as shown in Table 1, a titanium metal foil was immersed for 10 minutes at room temperature. The rest of the composition in Table 1 is water. The results are shown in Table 1. Further, with respect to the solubility of the titanium oxide, evaluation was made by ◯: the surface titanium oxide of the titanium metal foil was dissolved and discoloration was observed, and X: no change observed.

TABLE 1

Concentration (wt %)

| | Hydrogen | Ammonium | Solubility of |
|---|---|---|---|
| Examples | peroxide | carbonate | titanium oxide |
| 2 | 0.1 | 10 | ◯ |
| 3 | 0.5 | 3 | ◯ |
| 4 | 1 | 2 | ◯ |
| 5 | 1 | 1 | ◯ |
| 6 | 5 | 1 | ◯ |
| 7 | 10 | 0.5 | ◯ |
| 8 | 30 | 0.1 | ◯ |
| Comparative | 1 | 0 | X |
| Example 1 | | | |
| Comparative | 0 | 10 | X |
| Example 2 | | | |

### EXAMPLE 9

In 10 g of a 3.5% hydrogen peroxide solution, 1 g of ammoniumm carbonate (including ammonium hydrogencarbonate and ammonium carbamate) was dissolved. The liquid was heated to 40° C., and a titanium wafer having titanium deposited on a silicon wafer was immersed therein for 10 minutes. As a result, a surface titanium oxide on the titanium wafer was dissolved, and discoloration was observed.

### EXAMPLE 10

In 10 g of a 3.5% hydrogen peroxide solution, 0.1 g of ammonium carbonate (including ammonium hydrogencarbonate and ammonium carbamate) was dissolved. In the aqueous solution, an alumina powder containing 1,877 ppm of a titanium oxide was put. The solution was heated to 60° C. and stirred for 1 hour while hydrogen peroxide was blown thereinto. The alumina powder was filtrated and washed with deionized water and then fired at 600° C. for 2 hours in a flow of a dried air. The alumina powder was analyzed, and it was found that the titanium oxide was decreased to 212 ppm.

### EXAMPLE 11

In 10 g of ammonium carbonate (including ammonium hydrogencarbonate and ammonium carbamate) was dissolved in 1,050 of water, and 42 g of a 35% hydrogen peroxide solution was added to obtain a uniform solution. The concentration of hydrogen peroxide was obtained by titration, and was found to be 1.34%. In the mixed liquid, a titanium metal foil was immersed for 10 minutes at room temperature. As a result, a surface titanium oxide on the titanium metal toil was dissolved, and discoloration was observed.

Further, in the mixed liquid, an aluminum test specimen was immersed at 30° C., and the corrosion rate of aluminum was measured from the amount of decrease in weight. The corrosion rate was 0.175 μm/h.

After 10 days, the concentration of hydrogen peroxide was obtained by titration, and was found to be 1.17%.

### EXAMPLE 12

10 g of ammonium carbonate (including ammonium hydrogencarbonate and ammonium carbamate) was dissolved in 950 g of water, and 42 g of a 35% hydrogen peroxide solution and 100 g of butoxyethanol were added to obtain a uniform solution. The concentration of hydrogen peroxide was obtained by titration, and was found to be 1.34%. In the mixed liquid, a titanium metal foil was immersed for 10 minutes at room temperature. As a result, a surface titanium oxide on the titanium metal foil was dissolved, and discoloration was observed.

Further, in the mixed liquid, an aluminum test specimen was immersed at 30° C., and the corrosion rate of aluminum was measured from the amount of decrease in weight. The corrosion rate was 0.107 μm/h.

After 10 days, the concentration of hydrogen peroxide was obtained by titration, and was found to be 1.29%.

### COMPARATIVE EXAMPLE 3

In 10 g of a 3.5% hydrogen peroxide solution, a titanium metal foil was immersed for 10 minutes at room temperature. As a result, a surface titanium oxide on the titanium metal foil was not dissolved, and changes were not observed on the surface of the titanium metal foil.

### COMPARATIVE EXAMPLE 4

In a 10% aqueous solution (weight ratio) of ammonium carbonate (including ammonium hydrogencarbonate and ammonium carbamate), a titanium metal foil was immersed for 10 minutes at room temperature. As a result, a surface titanium oxide on the titanium metal foil was not dissolved, and changes were not observed on the surface of the titanium metal foil.

### COMPARATIVE EXAMPLE 5

In butoxyethanol, a titanium metal toil was immersed for 10 minutes at room temperature. As a result, a surface titanium oxide on the titanium metal foil was not dissolved, and changes were not observed on the surface of the titanium metal foil.

### EXAMPLE 13

In 10 g of a 3.5% hydrogen peroxide solution, 1 g of ammonium carbonate (including ammonium hydrogencarbonate and ammonium carbamate) and 1 g of dipropyiene glycol monomethyl ether were dissolved. The liquid was heated to 40° C., and a titanium wafer having titanium deposited on a silicon wafer was immersed therein for 10 minutes. As a result, a surface titanium oxide on the titanium wafer was dissolved, and discoloration was observed.

### EXAMPLE 14

In 10 g of a 3.5% hydrogen peroxide solution, 0.1 g of ammonium carbonate (including ammonium hydrogencarbonate and ammonium carbamate) and 10 g of methoxypropanol were dissolved, In the aqueous solution, an alumina powder containing 1,877 ppm of a titanium oxide was put. The aqueous solution was heated to 60° C. and stirred for 1 hour while hydrogen peroxide was blown thereinto. The alumina powder was filtrated and washed by deionized water, and then fired at 600° C. for 2 hours in a flow of a dry air. The alumina powder was analyzed, and it was found that the titanium oxide was decreased to 1,112 ppm.

### EXAMPLE 15

10 g of ammonium carbonate (including ammonium hydrogencarbonate and ammonium carbamate) was dissolved in 950 g of water, and 42 g of a 35% hydrogen peroxide solution and 100 g of dimethyl carbonate were added to obtain a uniform solution. The concentration of hydrogen peroxide was obtained by titration, and was found to be 1.34%. In the mixed liquid, a titanium metal foil was immersed for 10 minutes at room temperature. As a result, a surface titanium oxide on the titanium metal foil was dissolved, and discoloration was observed.

Further, in the mixed liquid, an aluminum test specimen was immersed at 30° C., and the corrosion rate of aluminum was measured from the amount of decrease in weight. The corrosion rate was 0.090 μm/h.

After 10 days, the concentration of hydrogen peroxide was obtained by titration, and was found to be 1.31%.

### COMPARATIVE EXAMPLE 6

In dimethyl carbonate, a titanium metal foil was immersed for 10 minutes at room temperature. As a result, a surface titanium oxide on the titanium metal foil was not dissolved, and changes were not observed on the surface of the titanium metal foil.

### EXAMPLE 16

In 10 g of a 3.5% hydrogen peroxide solution, 1 g of ammonium carbonate (including ammonium hydrogencarbonate and ammonium carbamate) and 1 g of propylene carbonate were dissolved. The liquid was heated to 40° C., and a titanium wafer having titanium deposited on a silicon wafer was immersed therein for 10 minutes. As a result, a surface titanium oxide on the titanium wafer was dissolved, and discoloration was observed.

### EXAMPLE 17

In 10 g of a 3.5% hydrogen peroxide solution, 0.1 g of ammonium carbonate (including ammonium hydrogencarbonate and ammonium carbamate) and 10 g of ethylene carbonate were dissolved. In the aqueous solution, an alumina powder containing 1,877 ppm of titanium oxide was put. The aqueous solution was heated to 60° C. and stirred for 1 hour while hydrogen peroxide was blown thereinto. The alumina powder was filtrated and washed with deionized water, and then fired for 2 hours at 600° C. in a flow of a dry air. The alumina powder was analyzed, and it was found that the titanium oxide was decreased to 1,200 ppm.

### EXAMPLES 18 TO 20

Into a solution having 1 g of ammonium carbonate (including ammonium hydrogencarbonate and ammonium carbamate) dissolved in 10 g of deionized water, an ozone gas was injected at room temperature.

The mixed liquid was heated to the temperature as shown in Table 2, and a titanium metal foil was immersed therein for the time as shown in Table 2. Evaluation was made by ◯: a surface titanium oxide on the titanium metal foil was dissolved, and discoloration was observed, and X: no discoloration observed, and the results are shown in Table 2.

### COMPARATIVE EXAMPLE 7

Into 10 g of deionized water, an ozone gas was injected at room temperature. The ozone water was heated to 90° C., and a titanium metal foil was immersed therein 10 for 10 minutes. The result is shown in Table 2.

### COMPARATIVE EXAMPLE 3

A 10% aqueous solution (weight ratio) of ammonium carbonate (including ammonium hydrogencarbonate and ammonium carbamate) was heated to 90° C., and a titanium metal foil was immersed therein for 10 minutes. The result is shown in Table 2.

TABLE 2

| | | | Discoloration |
|---|---|---|---|
| | Temperature | | of titanium |
| | (° C.) | Time (min) | surface |
| Example 18 | 90 | 10 | ◯ |
| Example 19 | 60 | 30 | ◯ |
| Example 20 | 30 | 60 | ◯ |
| Comparative | 90 | 10 | X |
| Example 7 | | | |
| Comparative | 90 | 10 | X |
| Example 8 | | | |

### EXAMPLE 21

A carbonic acid gas was injected into a 15% aqueous solution of tetramethylammonium hydroxide to adjust the pH to 10. Ozone was blown into the aqueous solution till saturation. The liquid was heated to 80° C., and a titanium wafer having titanium deposited on a silicon wafer was immersed therein for 10 minutes. As a result, a surface titanium oxide on the titanium wafer was dissolved, and discoloration was observed.

### EXAMPLE 22

An ammonium water was added to a 2% aqueous ammonium carbonate solution to adjust the pH to 9.4. In the aqueous solution, an alumina powder containing 1,877 ppm of a titanium oxide was put The aqueous solution was heated to 60° C., and then stirred for 1 hour while ozone was blown thereinto. The alumina powder was filtrated and washed with deionized water, and then fired at 600° C. for 2 hours in a flow of a dry air. The alumina powder was analyzed, and it was found that the amount of the titanium oxide was decreased to 630 ppm.

The composition for dissolving a titanium oxide and the dissolution method using it of the present invention provide a composition which dissolves a titanium oxide which is hardly soluble in water under safe conditions without using a dangerous material, and a dissolution method.

What is claimed is:

1. (canceled)

2. The method for dissolving a titanium oxide according to claim 9, wherein the content of the carbonic acid and/or the carbonate is from 0.01 to 40 wt %, the content of the hydrogen peroxide is from 10 ppm to 35 wt %, and the content of the water is from 25 to 99.9 wt %, on the basis of the total weight of the composition for dissolving a titanium oxide.

3. The method for dissolving a titanium oxide according to claim 9, wherein the carbonate is at least one member selected from the group consisting of ammonium carbonate, ammonium hydrogencarbonate and ammonium carbamate.

4. The method for dissolving a titanium oxide according to claim 9, which further comprises a water soluble organic solvent.

5. The method for dissolving a titanium oxide according to claim 4, wherein the content of the water soluble organic solvent is from 0.1 to 70 wt % on the basis of the total weight of the composition for dissolving a titanium oxide.

6. The method for dissolving a titanium oxide according to claim 4, wherein the water soluble organic solvent is an ether alcohol and/or a carbonate.

7. The method for dissolving a titanium oxide according to claim 6, wherein the ether alcohol is at least one member selected from the group consisting of butoxypropanol, butoxyethanol, propoxypropanol, propoxyethanol, ethoxypropanol, ethoxyethanol, methoxypropanol, methoxyethanol, dipropylene glycol monobutyl ether, dipropylene glycol monopropyl ether, dipropylene glycol monoethyl ether, dipropylene glycol monomethyl ether, diethylene glycol monobutyl ether, diethylene glycol monopropyl ether, diethylene glycol monoethyl ether, and diethylene glycol monomethyl ether.

8. The method for dissolving a titanium oxide according to claim 6, wherein the carbonate is at least one member selected from the group consisting of dimethyl carbonate, diethyl carbonate, ethylene carbonate and propylene carbonate.

9. A method for dissolving a titanium oxide as a surface film on titanium metal using a composition for dissolving a titanium oxide as which comprises carbonic acid and/or a carbonate hydrogen peroxide and water.

10. A method for dissolving a titanium oxide as an impurity produced in a step for producing semiconductors or in a step for producing LCD modules claimed in claim 9.

11. A method for dissolving a titanium oxide as an impurity contained in silica, alumina or ceria claimed in claim 9.

12-17. (canceled)
